(19) United States
(12) Patent Application Publication
(10) Pub. No.: US 2024/0327305 A1
(43) Pub. Date: Oct. 3, 2024

(54) A METHOD FOR PRODUCING A COMPOSITION CONTAINING CALCIUM WITH FIXED CO2 AND AN APPARATUS THEREFOR

(71) Applicant: Tokuyama Corporation, Shunan-shi (JP)

(72) Inventors: Kohei OMURA, Shunan-shi (JP); Takahiro ONISHI, Shunan-shi (JP)

(21) Appl. No.: 18/613,305

(22) Filed: Mar. 22, 2024

(30) Foreign Application Priority Data
Mar. 31, 2023 (JP) 2023-59643

(51) Int. Cl. C04B 40/02; B01D 53/62; C04B 7/36; C04B 22/00; C04B 111/00

(52) U.S. Cl. CPC C04B 40/0231; B01D 53/62; C04B 7/367; C04B 22/004; B01D 2251/404; B01D 2257/504; B01D 2258/0233; C04B 2111/00017

(57) ABSTRACT

A calcium-containing composition with fixed CO₂ is produced by contacting a mixture of a calcium-containing composition before CO₂ fixation and water with a CO₂-containing gas. The calcium-containing composition, liquid water, and the CO₂-containing gas having a temperature between 20 degree Celsius and 300 degree Celsius and a CO₂ concentration between 1 volume % and 100 volume % are supplied to a reactor. By the supplied CO₂-containing gas, the calcium-containing composition and water are made to flow in the reactor. Alternatively, the calcium-containing composition and water are in the reactor. Thus, CO₂ is fixed in the calcium-containing composition and simultaneously the calcium-containing composition is dried to a water content of 5 mass % or less.

### FIELD OF THE INVENTION

The present invention relates to a method for producing a composition containing calcium with fixed CO₂ and an apparatus therefor.

### BACKGROUND ART

CO₂ is a greenhouse gas and thus has an impact on global warming. In recent years, the reduction of CO₂ emissions has been demanded worldwide, especially in developed countries. Therefore, it is necessary to reduce the generation of CO₂ and to recover and effectively reuse CO₂ that has been generated. In the industrial sector, CO₂ emissions from thermal power plants and cement manufacturing plants are relatively large. Therefore, attempts in these facilities to reduce CO₂ emissions with reducing the use of fossil fuels, recovering CO₂ from the exhaust gas, and fixing the recovered CO₂ have been made.

Patent Document 1, for example, describes an attempt to fix CO₂ in concrete. This document describes that CO₂ is fixed by the reaction of calcium hydroxide formed during cement hydration and CO₂ to calcium carbonate.

Patent Document 2 describes producing construction materials suitable for fixing CO₂ in a short time. Specifically, alkaline solid materials such as coal ash are placed in a portable container or the like, and carbon dioxide gas is introduced into the container to carbonate the alkaline solid materials. The carbonation proceeds more quickly than conventional contact of CO₂ with concrete. Further calcium components such as calcium oxide in alkaline solid materials such as coal ash and incinerator ash are carbonated to form the calcium carbonate.

### PRIOR ART DOCUMENTS

### Patent Documents

Patent Document 1: JP 2020-37493A
Patent Document 2: JP 2021-155270A

### Non-Patent Document

Akifumi MOTOHATA, et al, Carbonation for Immobilization of lead in bottom ash, Environmental Engineering Research, Vol. 41, 2004, p. p. 459 Environmental Engineering Research, Vol. 41, 2004, p.p. 459-467 (Japanese Article)

### SUMMARY OF THE INVENTION

### Problem to be Solved

Various attempts have been made to make calcium components carbonated to fix CO₂, and the presence of water has been found for the efficient reaction between the calcium components and CO₂. This has been speculated because the calcium components react with water and change into calcium hydroxide which reacts easily with CO₂ to form calcium carbonate. The chemical reaction between calcium oxide and CO₂ is represented, for example, by equations (1) and (2).

CaO+H₂O→Ca(OH)₂. (1)

Ca(OH)₂+CO₂→CaCO₃+H₂O. (2)

For example, Non-Patent Document 1 describes the application of carbonation to insolubilize lead in incinerator ash. The document states that a large CO₂ amount is fixed when the water content of the incinerator ash is 10 to 20 mass %. However, since water is required for the CO₂ fixation, water remains problematically in the resultant product. For example, when the product is mixed with cement, the cement reacts undesirably with the water in the product. When the product is used during concrete production, the presence of water itself is allowable because water is mixed with cement and aggregate during the concrete production. However, since the exact water content can not be estimated, exact designing of the concrete becomes impossible, because the water content of the concrete becomes unknown. In addition, it becomes difficult to accurately control the water content because it varies upon various conditions, such as storage of the product and weather. Therefore, the presence of water in the product makes them less versatile due to the restrictions on their subsequent use.

On the other hand, when the product is dried separately from the carbonation, some energy is required. For example, when fossil fuels are used for the drying, they generate CO₂. Furthermore, both a reaction apparatus and a drying apparatus are required; the process is complicated.

Therefore, the problem of the invention is to obtain a flexibly usable carbonized calcium-containing product with low water content without emitting a large amount of CO₂ and under efficient carbonation conditions where water is present.

### Means for Solving the Problem

The inventor has been studying the above problems. Through comprehensive study, the inventors have found that the CO₂-containing gas used for the reaction between the mixture and the gas is effectively usable for the drying of the mixture and that the carbonation and the drying is capable of being carried out in a single apparatus. Furthermore, the inventors have succeeded in obtaining a calcium-containing composition with a small water content and a sufficient fixed CO₂ amount. Thus, the present invention was completed.

According to the invention, a method is provided for producing a calcium-containing composition with fixed CO₂, by making a mixture of a calcium-containing composition before fixing CO₂ and water in contact with a CO₂-containing gas. The method comprises the steps of:
supplying into a reactor the calcium-containing composition, liquid water, and a CO₂-containing gas having a temperature not less than 20 degree Celsius and not more than 300 degree Celsius and a CO₂ concentration not less than 1 volume % and not more than 100 volume %; and
fixing CO₂ to the calcium-containing composition and simultaneously drying the calcium-containing composition by making the calcium-containing composition and the water flow in the reactor by the CO₂-containing gas supplied, or alternatively by agitating the calcium-containing composition and the water in the reactor,
wherein the calcium-containing composition with fixed CO₂ has a water content not more than 5 mass %.

According to the invention, the fixing of CO₂ and the drying of the calcium-containing composition are carried out simultaneously in the reactor.

Preferably, the water amount mixed with 100 mass parts of the calcium-containing composition before fixing CO₂ in a dry state is made not less than 10 mass parts and more preferably, made not less than 10 mass parts and not more than 30 mass parts.

Preferably, the temperature of the CO₂-containing gas is made not lower than 60 degree Celsius and more preferably, made not lower than 100 degree Celsius.

Preferably, the water content of the calcium-containing composition with fixed CO₂ is made not more than 1 mass %. Further preferably, the CO₂ fixation and the drying are carried out in a single reactor, and most preferably, the reactor is a fluidized bed reactor.

Preferably, the CO₂-containing gas is extracted from a cement clinker production plant or extracted from a thermal power generation plant.

Preferably, the liquid water contains ammonia.

Preferably, the calcium-containing composition with fixed CO₂ is mixed into cement to a concentration not more than 5 mass %.

Preferably, the calcium-containing composition with fixed CO₂ is used as a concrete mixture material.

An apparatus according to the invention, for producing a calcium-containing composition with fixed CO₂, by making a mixture of a calcium-containing composition before fixing CO₂ and water in contact with a CO₂-containing gas, comprises:
a storage facility for storing the calcium-containing composition;
a fluidized bed reactor for carrying out carbonation of the calcium-containing a metered-volume feeder for supplying the calcium-containing composition to the fluidized bed reactor;
a water injection device for mixing water into the calcium-containing composition, before feeding to the fluidized bed reactor, preferably in the metered-volume feeder;
a blower for supplying the CO₂-containing gas to the fluidized bed reactor;
a dust collector for collecting dust contained in exhaust gas from the fluidized bed reactor; and
a blower for suctioning the exhaust gas from the dust collector.

### Advantages of the Invention

According to the present invention, a calcium-containing composition with a small water content and a sufficient fixed CO₂ amount can be obtained without emitting a large amount of CO₂ and with the presence of enough water to accelerate the carbonation.

### BRIEF DESCRIPTION OF THE DRAWINGS

FIG. 1 is a schematic diagram of an apparatus having a fluidized bed reactor for producing a calcium-containing composition with fixed CO₂, according to an embodiment.

FIG. 2 is a schematic diagram of the apparatus used in the test.

FIG. 3 is a characteristic diagram showing the major data in Table 3.

FIG. 4 is a characteristic diagram showing the major data in Table 4.

FIG. 5 is a schematic diagram of an apparatus according to a second embodiment.

### FEATURES FOR CARRYING OUT THE INVENTION

According to the present invention, a calcium-containing composition before carbonation is mixed with water, and, then, CO₂-containing gas is made into contact with the composition for both the carbonation and the drying of the mixture. This results in the low water content of the composition up to 5 mass %, and preferably, up to 1 mass %; here the CO₂-fixed calcium-containing composition (the resultant composition) is set at 100 mass %. The respective operations in the process, such as the mixing of the calcium-containing composition with water and the carbonation of the composition, may be performed continuously or in batches.

The calcium-containing composition before carbonation is not limited in the calcium content as long as the composition contains calcium. However, a high calcium content is preferable in order to sufficiently fix CO₂. Calcium-containing compositions include, for example, incinerator ash from general waste, coal ash generated in thermal power plants, biomass ash generated from biomass fuel or a mixture fuel of coal and biomass in thermal power plants, slag generated in iron and steel plants or other metal refining plants, sludge slag, cement, gypsum, quicklime, slaked lime, etc. However, if all of the calcium in the composition is calcium carbonate, further carbonation, ie. fixation of CO₂, is not possible, and such compositions are excluded from the calcium-containing compositions according to the present invention. Calcium-containing compositions having crystalline calcium are preferable in terms of good reactivity with CO₂. When all of the calcium is amorphous, the calcium is less reactive with CO₂ and less efficient in fixing CO₂. However, when at least some of the calcium in the composition is present in crystalline forms other than calcium carbonate, the composition can be used. Crystalline forms other than calcium carbonate include, for example, those of calcium oxide, calcium sulfate, calcium hydroxide, calcium silicate, calcium chloride, calcium aluminate, and so on. Whether the calcium is crystalline or amorphous can be determined by X-ray diffraction. The presence or absence and amount of crystalline calcium oxide can be determined by JCAS I-01-1997 “Determination Method for Free Calcium Oxide.

The type of water to be mixed with the composition before the carbonation is not limited. Tap water, industrial water, etc. can be used, and further, rainwater, seawater, wastewater, and cooling water generated from surrounding facilities and equipment can be used. The water contains preferably ammonia because the ammonia in the water promotes the carbonation. The concentration of ammonia is not particularly limited; 10 mass % of ammonia is sufficient and the ammonia concentration is, for example, from 1 to 10 mass %.

The water amount mixed with the calcium-containing composition before carbonation is preferably at least 10 mass parts to 100 mass parts of the composition in a dry state. More preferably, it is not less than 10 mass parts and not more than 30 mass parts. The larger the water content, the more the CO₂ fixation reaction is promoted, while too much water increases the time and energy required for drying. Water contents exceeding 30 mass parts do not result in a significant increase in the fixed CO₂ amount. Therefore, it is preferable to set the upper limit at 30 mass parts for practical use.

The calcium-containing composition and water are mixed before carbonation. In mixing, known techniques and equipment can be used. For example, during transport of the calcium-containing composition to the reactor, the composition can be sprinkled and mixed with water. Similarly, the calcium-containing composition and water can be supplied separately into a mixer and carbonized in the mixer, or then, uniformly fed to a separate reactor.

After the mixing or simultaneously with the mixing, the mixture of the calcium-containing composition and water is made in contact with a CO₂-containing gas. The CO₂ concentration of the gas is not particularly limited. However, in order to carry out the carbonation efficiently, it is preferable to supply a larger amount of CO₂ than the amount that the calcium-containing composition can fix. For example, suppose that a calcium-containing composition containing 1 mass % crystalline calcium oxide is fed into the reactor at 100 kg/hr to carry out the carbonation continuously. For example, calcium oxide capable of fixing CO₂ is supplied at a rate of 100 kg/hr×1 mass %=1 kg/hr. The carbonation of calcium oxide proceeds according to equations (1) and (2). Here, 1 kg of calcium oxide (molar mass: 56.1 kg/kmol) is 0.018 kmol according to equation (3). The CO₂ that reacts with 0.018 kmol of CaO consists of 0.018 kmol, according to equations (1) and (2). Therefore, assuming CO₂ is at standard temperature and pressure since the volume of 1 kmol of gas at standard temperature and pressure is 22.4 Nm³ (normal cubic meter), 0.4 Nm³ of CO₂ is required according to equation (4) below.

1 kg/hr÷56.1 kg/kmol=0.018 kmol/hr. (3)

22.4 Nm³/kmol×0.018 kmol/hr=0.4 Nm³/hr. (4)

Thus, for example, when a calcium-containing composition containing 1 mass % crystalline calcium oxide is fed into the reactor at a rate of 100 kg/hr, it is desirable to supply CO₂ at a rate of 0.4 Nm³/hr or higher. Then, when the CO₂ concentration of the gas is 1 volume %, preferably, the gas more than 40 Nm³/hr is supplied to the reactor, and when the CO₂ concentration is 10 volume %, preferably, the gas more than 4 Nm³/hr is supplied.

In the reaction apparatus, ie, the reactor, at the same time as CO₂ is fixed in the composition, the composition is dried. Generally, a gas with a higher temperature is suitable for drying. For example, gases extracted from thermal power plants, cement clinker plants, chemical product manufacturing plants, and waste incineration plants are suitable because they have a temperature above room temperature. The temperature of the gas is preferably above room temperature, but a too high temperature may be problematic, because water must intervene in the carbonation of the calcium-containing composition. When the gas temperature is too high, the calcium-containing composition dries out before the carbonation, and sufficient reaction time cannot be ensured. Therefore, the temperature of the gas supplied to the reactor is preferably adjusted to be 20 degree Celsius or higher and 300 degree Celsius or lower, more preferably, 60 degree Celsius or higher and 300 degree Celsius or lower, and, most preferably, 100 degree Celsius or higher and 200 degree Celsius or lower. When the temperature of the CO₂-containing gas is too low, the gas is preheated to a suitable temperature. The amount of CO₂ produced in the process shall be smaller than that fixed in the process. Therefore, when fossil fuels are used, the generated CO₂ amount shall be less than the fixed CO₂ amount. This does not apply when renewable or natural energy sources are used for heating the gas.

The time required for the reaction is set appropriately according to the amount of the mixture of calcium-containing composition and water supplied to the reactor, the amount, temperature, and concentration of CO₂-containing gas, and so on.

The relative humidity of the CO₂-containing gas is, for example, up to 90% and above 0%, preferably up to 60% and above 0%.

The CO₂ concentration of the CO₂-containing gas is preferably not less than 1 volume percent and not more than 100 volume %, more preferably, not less than 10 volume % and not more than 100 volume %, and, most preferably, not less than 20 volume % and not more than 100 volume %.

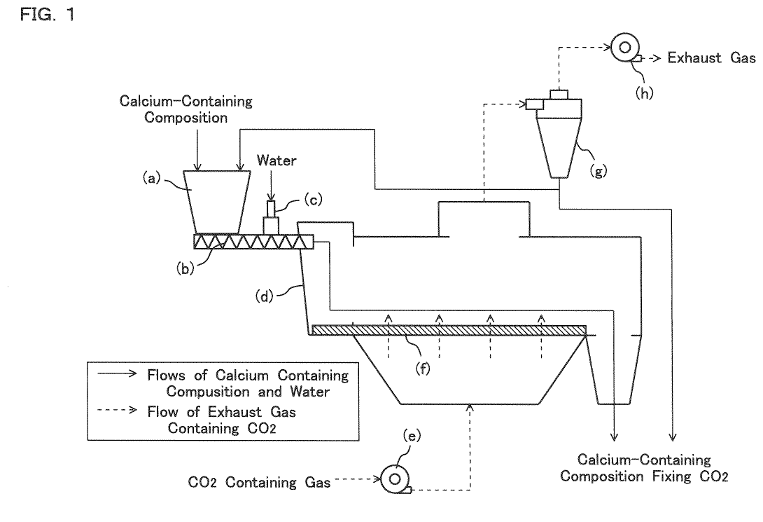

The reaction apparatuses usable are those capable of supplying powder, ie, the mixture, and gas and bringing them into contact. Suitable examples are fluidized bed reactors and rotary dryers. Fluidized bed reactors have been used for drying and incinerating powders as fluidized bed dryers and fluidized bed incinerators. The reaction apparatus of the embodiment will be described in detail with reference to FIG. 1; the invention is not limited to the embodiment.

In FIG. 1, a calcium-containing composition storage facility (a) stores calcium-containing compositions before carbonation. The calcium-containing composition is extracted downward from the storage facility (a) and then, transported and supplied to the fluidized bed reactor (d) by a constant volume metering device (b). In the process of transport, a water injection device (c) mixes a predetermined amount of water into the calcium-containing composition before carbonation. The mixture of calcium-containing composition and water is then supplied to the fluidized bed reactor (d). The solid arrows indicate the flow of the calcium-containing composition and water.

The CO₂-containing gas is supplied from the lower portion of the fluidized bed reactor (d) by a blower (e), as shown in FIG. 1. The gas is dispersed by a dispersion plate (f) and, then, comes into contact with the calcium-containing composition such that the carbonation, ie. the CO₂ fixation reaction, and the drying of the composition are both carried out. The exhaust gas is discharged from an upper portion of the reactor (d), and, after dust collection by a dust collector (g), exhausted by a blower (h). The powder collected by the dust collector (g) is returned to the storage facility (a) for storing the calcium-containing composition or mixed with the product, ie. the CO₂-fixed ss calcium-containing composition.

The fixed CO₂ amount in the resultant calcium-containing composition varies depending on the type and composition of the calcium-containing composition used. Therefore, the fixed CO₂ amount is not limited. However, when considering the CO₂ amounts needed for the generation of the electricity in the production process and in the usage of the CO₂-fixed calcium-containing composition, and generated by the fuel for transportation, a small fixed CO₂ amount in the composition is not meaningful. For this reason, it is preferable that at least 1 mass % of CO₂ is fixed when the calcium-containing composition after CO₂ fixation is 100 mass %. More preferably, at least 2 mass % of CO₂ is fixed. When the calcium-containing composition contains calcium carbonate prior to the fixation of CO₂, the amount of the pre-existing calcium carbonate is determined in advance. Specifically, the CO₂ amount originally contained in the calcium-containing composition before CO₂ fixation is subtracted from that after the carbonation. In principle, a TG-DTA apparatus is used in the measurement of the fixed CO₂ amount in the present invention. In the TG-DTA apparatus, a predetermined amount of the calcium-containing composition after CO₂ fixation is fed, and the temperature is increased from room temperature to 1000 degree Celsius in a nitrogen atmosphere at a rate of 10 degree Celsius/min. The fixed CO₂ amount is determined by the mass loss in the temperature range from 550 degree Celsius to 700 degree Celsius. Alternatively, the amount of calcium carbonate may be determined by, for example, a coulometer, a TOC meter, a CHN meter, or by X-ray diffraction/Rietveld method. In these measurements, the fixed CO₂ amount is determined to fully correlate to the TG-DTA measurement.

The water content of the calcium-containing composition as the product is to be up to 5 mass % where the total amount of the composition is 100 mass %. When the water content exceeds 5 mass %, the composition becomes difficult to be handle in the same way as usual dry powders. Preferably, the water content of the calcium-containing composition as the product is up to 1 mass %. When the product will be mixed with Portland cement or mixed cement, water content up to 1 mass % shall not make the cement and water react nor harden the cement before using the cement. In addition, when the product will be used as an ingredient for concrete, the water in the product shall not affect the quality of concrete or concrete mix design. For reference, fly ash is suitably mixed with cement and concrete, and JIS A 6201, “fly ash for concrete,” requires the water content of fly ash for concrete is up to 1 mass %.

Thus produced calcium-containing compositions with fixing CO₂ are usable as it is or are mixed with other materials. Examples of usages include mixing into cement; mixing into cementitious materials such as cementitious solidifiers and mortars; and mixing into concrete.

### EMBODIMENTS

Embodiments and comparative examples will be described below. The present invention is not limited to the embodiments.

The ash obtained from the co-combustion of coal and biomass fuel (hereinafter “biomass ash”) was used as the calcium-containing composition before CO₂ fixation. The composition of the biomass ash measured by X-ray fluorescence analysis is shown in Table 1, and the types of calcium measured by X-ray diffraction/Rietveld method are shown in Table 2. The biomass ash contained 11.1 mass % of calcium in toal: 4.0 mass % of crystalline calcium oxide, which contributes to carbonation, and 0.5 mass % of calcium sulfate in oxide equivalents. In Tables 1 and 2, the content is shown in oxide reduction. Ten grams of the resultant calcium-containing composition after CO₂ fixation was placed on a stainless steel bat and dried in a dryer at 100 degree Celsius for 24 hours. The water content of the CO₂-fixed calcium-containing composition was calculated from the mass loss in this process.

The CO₂ amount originally contained in the biomass ash and the fixed CO₂ amount in the product after CO₂ fixation of a predetermined reaction time were measured by a TG-DTA apparatus. A predetermined amount of sample was fed into the TG-DTA apparatus, and the temperature was increased from room temperature to 1000 degree Celsius at a rate of 10 degree Celsius/min in a nitrogen atmosphere. The mass loss in the TG curve obtained in the range of 550 degree Celsius to 700 degree Celsius was assumed to be due to the decomposition of calcium carbonate, and defined as the fixed CO₂ amount. The fixed CO₂ amount in the calcium-containing composition was determined by subtracting the CO₂ amount originally contained in the biomass ash which was 1.5 mass %.

TABLE 1

| Material | Content (mass %) |
|---|---|
| water | 0.5 |
| Ignition Loss | 9.9 |
| SiO₂ | 44.2 |
| Al₂O₃ | 11.2 |
| Fe₂O₃ | 16.3 |
| CaO | 11.1 |
| MgO | 1.7 |
| Na₂O | 1.9 |
| K₂O | 1.6 |
| TiO₂ | 0.4 |
| P₂O₅ | 1.1 |
| Total | 100 |

TABLE 2

| | | Content |
|---|---|---|
| Species of Calcium | | (mass %) |
| Sates Contributing | Calcium Oxide | 4.0 |
| to Carbonation | Calcium Sulphate | 0.5 |
| Sates Not Contributing | Calcium Carbonate | 1.9 |
| to Carbonation | Amorphous Calcium | 4.7 |

| | |
|---|---|
| Total | 11.1 |

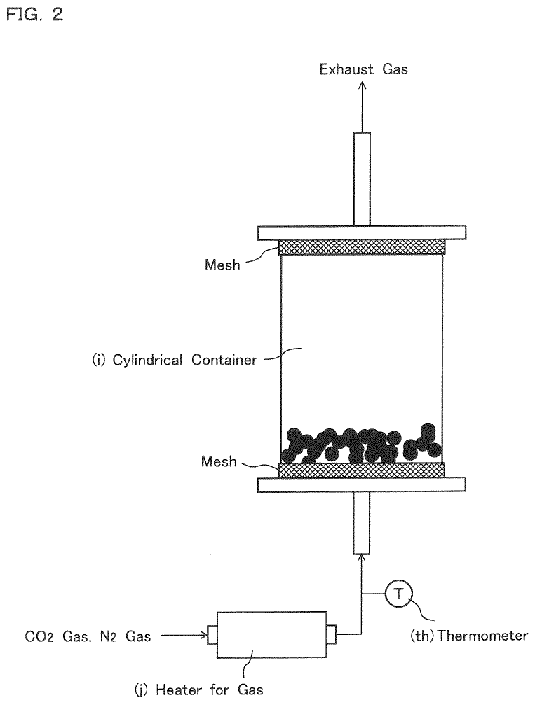

CO₂ fixation into the biomass ash was performed by the apparatus shown in FIG. 2. This apparatus simulates a fluidized bed reactor. A cylindrical vessel (i) with an inner diameter of 40 mm was covered with a mesh top and bottom, and a mixture of biomass ash and water was placed inside. In all cases, 50 g of biomass ash in a dry state was used, and 10 to 40 mass parts of water were pre-mixed with 100 mass parts of the dry biomass ash. As an alternative example, 20 mass parts of 10 mass % ammonia water were mixed with the dry biomass ash instead of simple water. Then, CO₂-containing gases were supplied through holes at the bottom of the apparatus, were made reacted with the biomass ash, and dried the biomass ash. The exhaust gases were discharged through a mesh at the upper portion. In FIG. 2, (j) denotes a heater for heating the gases, and (th) denotes a thermometer for measuring the gas temperature.

Commercially available carbon dioxide gas was used for preparing the CO₂-containing gas. Two CO₂ concentrations were tested: 100 volume % and 20 volume %. For adjusting the CO₂ concentration to 20 volume %, commercially available N2 gas was mixed with CO₂.

The temperature of the gas supplied to the reactor was set at three values: 20 degree Celsius; 60 degree Celsius; and 100 degree Celsius. To maintain the temperatures, the gas was heated to the temperatures before being supplied into the cylindrical vessel.

The flow rate of the CO₂-containing gas was kept to 10 L/min at standard temperature and pressure, regardless of the CO₂ concentration.

Tables 3, 4, and 5 show the reaction conditions and results. Items (1) through (7) in the tables mean the following:
(1) Water amount mixed into 100 mass parts of the calcium-containing composition (in mass parts);
(2) CO₂ concentration of the CO₂-containing gas (in volume percent); and
(3) Temperature of the CO₂-containing gas (in degree Celsius)
(4) Reaction time (in minutes);
(5) The fixed CO₂ amount in the resultant calcium-containing composition (the CO₂ amount originally contained in the calcium-containing composition is subtracted);
(6) The ratio of the fixed CO₂ amount (mass %) to the maximum fixed CO₂ amount (mass %) without the water addition (hereinafter “the reference ratio”); and
(7) The water content (in mass %) of the resultant CO₂-fixed calcium-containing composition.

TABLE 3

| | Examples | | | | | | |
|---|---|---|---|---|---|---|---|
| | | | | (4) | | (6) | |
| | | | | Reaction | (5) | Ratio | (7) |
| | (1) | (2) | (3) | Time | Fixed | to | Water |
| | Water | CO₂ % | T | (min.) | CO₂ | Ref. | (mass %) |
| Comp. 1 | 0 | 100 | 20 | 10 | 1.1 | 0.9 | 0 |
| Comp. 2 | 0 | 100 | 20 | 20 | 1.2 | 1.0 | 0 |
| Comp. 3 | 0 | 100 | 20 | 30 | 1.2 | 1.0 | 0 |
| Comp. 4 | 0 | 100 | 20 | 60 | 1.2 | 1.0 | 0 |
| Comp. 5 | 10 | 100 | 20 | 10 | 1.7 | 1.4 | 7.4 |
| Comp. 6 | 10 | 100 | 20 | 20 | 1.7 | 1.4 | 6.8 |
| Comp. 7 | 10 | 100 | 20 | 30 | 1.6 | 1.3 | 6.2 |
| Emb. 1 | 10 | 100 | 20 | 60 | 1.7 | 1.4 | 4.2 |
| Emb. 2 | 10 | 100 | 20 | 90 | 1.7 | 1.4 | 0.4 |
| Comp. 8 | 20 | 100 | 20 | 10 | 2.1 | 1.8 | 17.2 |
| Comp. 9 | 20 | 100 | 20 | 20 | 2.0 | 1.7 | 16.5 |
| Comp. 10 | 20 | 100 | 20 | 30 | 2.1 | 1.8 | 13.7 |
| Comp. 11 | 20 | 100 | 20 | 60 | 2.1 | 1.8 | 8.3 |
| Emb. 3 | 20 | 100 | 20 | 90 | 2.1 | 1.8 | 3.3 |
| Emb. 4 | 20 | 100 | 20 | 120 | 2.1 | 1.8 | 0.8 |
| Comp. 12 | 30 | 100 | 20 | 10 | 2.9 | 2.4 | 26.5 |
| Comp. 13 | 30 | 100 | 20 | 20 | 2.7 | 2.3 | 23.9 |
| Comp. 14 | 30 | 100 | 20 | 30 | 2.9 | 2.4 | 22.2 |
| Comp. 15 | 30 | 100 | 20 | 60 | 3.1 | 2.6 | 14.3 |
| Comp. 16 | 30 | 100 | 20 | 90 | 3.0 | 2.5 | 6.9 |
| Emb. 5 | 30 | 100 | 20 | 120 | 3.1 | 2.6 | 2.9 |
| Emb. 6 | 30 | 100 | 20 | 180 | 3.1 | 2.6 | 0.2 |
| Comp. 17 | 40 | 100 | 20 | 10 | 2.8 | 2.3 | 38.2 |
| Comp. 18 | 40 | 100 | 20 | 20 | 2.9 | 2.4 | 34.8 |
| Comp. 19 | 40 | 100 | 20 | 30 | 3.1 | 2.6 | 31.0 |
| Comp. 20 | 40 | 100 | 20 | 60 | 3.0 | 2.5 | 22.8 |
| Comp. 21 | 40 | 100 | 20 | 90 | 3.0 | 2.5 | 14.1 |
| Comp. 22 | 40 | 100 | 20 | 120 | 2.9 | 2.4 | 7.3 |
| Emb. 7 | 40 | 100 | 20 | 180 | 3.0 | 2.5 | 3.0 |
| Emb. 8 | 40 | 100 | 20 | 210 | 3.1 | 2.6 | 0.9 |

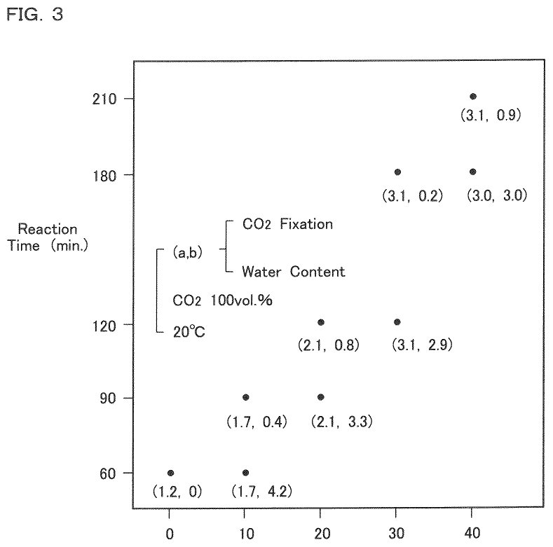

Table 3 shows the results when the CO₂ concentration of the gas was fixed at 100 volume % and the gas temperature was fixed at 20 degree Celsius. The major data in Table 3 are reproduced in FIG. 3. The horizontal axis indicates the water amount mixed into the calcium-containing composition and the vertical axis indicates the reaction time. The data indicate the pair of the fixed CO₂ amount and the water content of the resultant calcium-containing composition, after CO₂ fixation. A short reaction time, a high fixed CO₂ amount, and a low water content are desirable. From FIG. 3, it was found that the amount of mixed water is preferably not less than 10 mass parts and not more than 30 mass parts.

Comparative examples 1˜4 indicate those without water addition. The fixed CO₂ amount remained constant after the reaction of 20 minutes and was 1.2 mass % at maximum. In the following, the standard ratios in item (6) in the tables are the fixed CO₂ amounts relative to the maximum fixed CO₂ amount (1.2 mass %) without water addition.

In Comparative Examples 5-7 and Embodiments 1 and 2, 10 mass parts of water were mixed with 100 mass parts of the calcium-containing composition. With mixing 10 mass parts of water, the fixed CO₂ amount increased to 1.7 mass %, with a standard ratio of 1.4. According to Comparative Examples 5-7 with a reaction time up to 30 minutes, the water contents of the resultant calcium-containing composition were not suitable in exceeding 5 mass %. In Embodiment 1 with a reaction time of 60 minutes, the resultant water content was 4.2 mass % and suitable. In Embodiment 2, the resultant water content was 0.4 mass % and more suitable for use.

In Comparative Examples 8-11 and Embodiments 3 and 4, 20 mass parts of water were mixed with 100 mass parts of the calcium-containing composition. With mixing 20 mass parts of water, the fixed CO₂ amount increased further to 2.1 mass % at maximum, with a standard ratio of 1.8. In Comparative Examples 8-11 with a reaction time up to 60 minutes, the water content of the resultant CO₂-fixed calcium-containing composition was not suitable in exceeding 5 mass %. In Embodiment 3 with a reaction time of 90 minutes, the resultant water content was 3.3 mass % and suitable. In Embodiment 4, the resultant water content was 0.8 mass % and more suitable.

In Comparative Examples 12-16 and Embodiments 5 and 6, 30 mass parts of water were mixed with 100 mass parts of the calcium-containing composition. With mixing 30 mass parts of water, the fixed CO₂ amount increased further to 3.1 mass % at maximum with the standard ratio of 2.6. In Comparative Examples 12-16 with a reaction time up to 90 minutes, the water content of the resultant composition was not suitable in exceeding 5 mass %. In Embodiment 5 with a reaction time of 120 minutes, the resultant water content was 2.9 mass % and suitable. In Embodiment 6, the resultant water content was 0.2 mass % and more suitable.

In Comparative Examples 17-22 and Embodiments 7 and 8, 40 mass parts of water were mixed with 100 mass parts of the calcium-containing composition. While 40 mass parts of water were mixed, there was found no significant difference in the fixed CO₂ amount compared to those with 30 mass parts of water. The water content of the resultant composition was not suitable in exceeding 5 mass % up to 120 minutes, as in Comparative Examples 17-22. In Embodiment 7 with a 180 minutes, the resultant water content was 3.0 mass % and suitable. In Embodiment 8, the resultant water content was 0.9 mass % and more suitable.

In Comparative Examples 17-22 and Embodiments 7 and 8, while the water contents of the resultant compositions were similar compared to those in Comparative Examples 12-16 and Embodiments 5 and 6, the drying process required more time. Considering the relatively high water contents and the relatively large energy for drying, water addition over 30 mass parts was found not suitable under the conditions of these examples.

TABLE 4

| | Examples | | | | | | |
|---|---|---|---|---|---|---|---|
| | | | | (4) Re- | | (6) | |
| | | | | action | (5) | Ratio | (7) |
| | (1) | (2) | (3) | Time | Fixed | to | Water |
| | Water | CO₂ % | T | (min.) | CO₂ | Ref. | (mass %) |
| Comp. 23 | 20 | 20 | 20 | 10 | 2.6 | 2.1 | 17.2 |
| Comp. 24 | 20 | 20 | 20 | 20 | 2.3 | 1.9 | 15.4 |
| Comp. 25 | 20 | 20 | 20 | 30 | 2.3 | 1.9 | 13.7 |
| Comp. 26 | 20 | 20 | 20 | 60 | 2.4 | 2.0 | 9.0 |
| Emb. 9 | 20 | 20 | 20 | 90 | 2.3 | 1.9 | 4.1 |
| Emb. 10 | 20 | 20 | 20 | 120 | 2.3 | 1.9 | 1.0 |
| Comp. 27 | 20 | 20 | 60 | 10 | 2.3 | 1.9 | 10.2 |
| Emb. 11 | 20 | 20 | 60 | 20 | 2.3 | 1.9 | 4.4 |
| Emb. 12 | 20 | 20 | 60 | 30 | 2.3 | 1.9 | 0.9 |
| Emb. 13 | 20 | 20 | 100 | 10 | 2.4 | 2.0 | 4.0 |
| Emb. 14 | 20 | 20 | 100 | 20 | 2.3 | 1.9 | 1.0 |

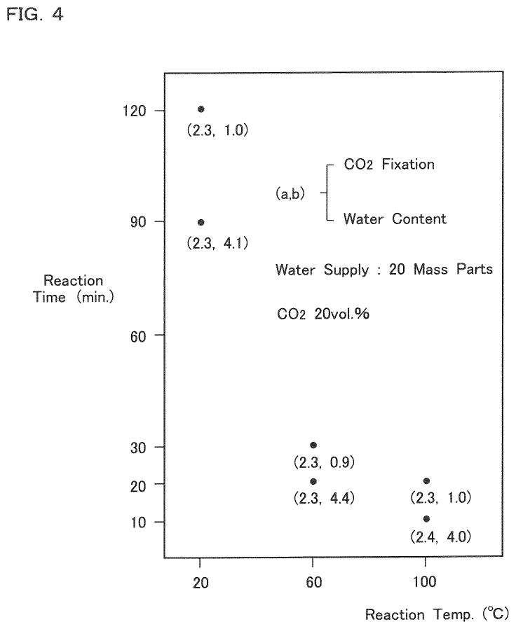

Table 4 shows the results where 20 mass parts water was mixed to 100 mass parts of calcium-containing composition and the CO₂ concentration of the gas was set to 20 volume %. The major data in Table 4 are reproduced in FIG. 4. In FIG. 4, the horizontal axis indicates the reaction temperature and the vertical axis indicates the reaction time. FIG. 4 indicates the pairs of the fixed CO₂ amount and the water content of the resultant calcium-containing composition after CO₂ fixation. A short reaction time, a high fixed CO₂ amount, and a low water content are desirable. FIG. 4 shows that a reaction temperature of 60 degree Celsius or higher is preferable, and 100 degree Celsius or higher is more preferable.

In Comparative Examples 23-26 and Embodiments 9-10, the CO₂ concentration of the gas was reduced to 20 volume % from the conditions in Comparative Examples 8-11 and Embodiments 3-4. Compared to Comparative Examples 8-11 and Embodiments 3-4, the fixed CO₂ amounts were almost the same. The required time for reducing the water content of the resultant composition up to 5 mass % was also 90 minutes, which was equivalent to those in Comparative Examples 8-11 and Embodiments 3-4. Thus, it was found that, in the CO₂ fixation reaction, the CO₂ concentration can be low as long as sufficient CO₂ is supplied for the reaction with the calcium-containing composition.

In Comparative Example 27 and Embodiments 11 and 12, the temperature of the gas was set at 60 degree Celsius. Compared to Comparative Examples 23-26 and Embodiments 9 and 10 where the temperature was 20 degree Celsius, the fixed CO₂ amount was almost the same. The water contents of the resultant composition decreased to 4.4 mass % at 20 minutes and to 0.9 mass % at 30 minutes. Thus, a suitably usable CO₂-fixed calcium-containing composition was obtained in a shorter time.

In Embodiments 13 and 14, the temperature of the gas was set at 100 degree Celsius. Compared to Comparison 27 and Embodiments 11 and 12 where the temperature was 60 degree Celsius, the fixed CO₂ amounts were almost the same. The water content of the resultant CO₂-fixed calcium-containing composition decreased to 4.0 mass % at 10 minutes and to 1.0 mass % at 20 minutes, and thus a suitably usable, CO₂-fixed calcium-containing composition was obtained in a shorter time.

TABLE 5

| | Examples | | | | | | |
|---|---|---|---|---|---|---|---|
| | | | | (4) | | | |
| | (1)10% | | | Reaction | | (6) | |
| | Ammonia | (2) | (3) | Time | (5) | Ratio | (7) |
| | Water | CO₂ % | T | (min.) | Fixed | CO₂ | to Ref. |
| (mass %) | | | | | | | |
| Comp. 28 | 20 | 20 | 20 | 10 | 3.3 | 1.8 | 17.0 |
| Comp. 29 | 20 | 20 | 20 | 20 | 3.3 | 1.8 | 14.6 |
| Comp. 30 | 20 | 20 | 20 | 30 | 3.5 | 1.9 | 12.6 |
| Comp. 31 | 20 | 20 | 20 | 60 | 3.1 | 1.7 | 8.4 |
| Emb. 15 | 20 | 20 | 20 | 90 | 3.4 | 1.8 | 3.9 |
| Emb. 16 | 20 | 20 | 20 | 120 | 3.4 | 1.8 | 0.9 |

In Table 5, the calcium-containing compositions of 100 mass parts were mixed with 20 mass parts of 10 mass % ammonia water; the CO₂ concentration of the gas was set to 20 volume %, and the temperature of the gas was set to 20 degree Celsius.

In Comparative Examples 28-31 and Embodiments 15 and 16, 10 mass % ammonia water was used instead of simple water. Compared to Comparative Examples 23-26 and Embodiments 9 and 10, the fixed CO₂ amounts increased to 3.5 mass % at maximum with the maximum standard ratio of 1.9. The time until the water content of the resultant composition became below 5 mass % was similarly 90 minutes. In other words, the addition of ammonia water accelerated the CO₂ fixation reaction.

### Embodiment 2

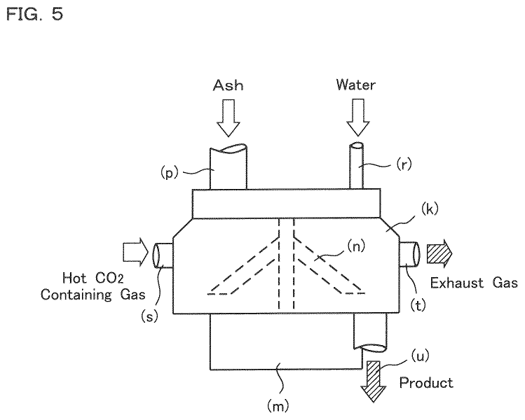

In the fluidized bed reactor (d) of FIG. 1, CO₂ was absorbed quickly and a small amount of thermal energy was required to obtain a dry, CO₂-fixed calcium-containing composition. This is because the fluidized bed brings the calcium-containing composition into uniform contact with the CO₂-containing gas. However, the fluidized bed reactor (d) is not suitable for small-scale plants. A second embodiment of a reactor suitable for small-scale plants is shown in FIG. 5.

An agitator blade (n) is placed in a closed housing (k) and rotated by a motor (m). Calcium-containing compositions such as incinerated ash are fed through the ash inlet (p), and water is fed through the water inlet (r). CO₂-containing gas is introduced from the gas inlet(s), and, from the exhaust gas outlet, exhaust gas after supplying CO₂ to the calcium-containing composition and receiving water vapor is discharged. The resultant calcium-containing composition with fixed CO₂ is then discharged from the outlet (u). The apparatus in FIG. 5 has lower CO₂ absorption efficiency and lower thermal efficiency than the apparatus in FIG. 1. However, the apparatus in FIG. 5 is smaller in scale and has lower equipment costs than the apparatus in FIG. 1. The embodiment of FIG. 5 is the same to the embodiment in FIGS. 1 to 4, except for specifically noted points.

### LIST OF SYMBOLS

(a) Calcium-containing composition storage facility
(b) Constant volume feeding device
(c) Water injection device
(d) Fluidized bed reactor
(e) Blower
(f) Dispersion plate
(g) Dust collector
(h) Blower
(k) Housing
(m) Motor
(n) Agitator blade
(p) Ash inlet
(r) Water inlet(s)
(s) CO₂-containing gas inlet
(t) Exhaust gas outlet
(u) Product outlet

What is claimed is:

1. A method for producing a calcium-containing composition with fixed CO₂, by making a mixture of a calcium-containing composition before fixing CO₂ and water in contact with a CO₂-containing gas, comprising the steps of:
supplying into a reactor the calcium-containing composition, liquid water, and a CO₂-containing gas having a temperature not less than 20 degree Celsius and not more than 300 degree Celsius and a CO₂ concentration not less than 1 volume % and not more than 100 volume %; and
fixing CO₂ to the calcium-containing composition and simultaneously drying the calcium-containing composition by making the calcium-containing composition and the water flow in the reactor by the CO₂-containing gas supplied, or by agitating the calcium-containing composition and the water in the reactor,
wherein the calcium-containing composition with fixed CO₂ has a water content not more than 5 mass %.

2. The method for producing a calcium-containing composition with fixed CO₂ according to claim 1, wherein the calcium-containing composition before fixing CO₂ is at least one member of the group consisting of ash, slag, and sludge.

3. The method for producing a calcium-containing composition with fixed CO₂ according to claim 1, wherein the water amount mixed with 100 mass parts of the calcium-containing composition before fixing CO₂ in a dry state is made not less than 10 mass parts.

4. The method for producing a calcium-containing composition with fixed CO₂ according to claim 3, wherein the water amount mixed with 100 mass parts of the calcium-containing composition before fixing CO₂ in a dry state is made not less than 10 mass parts and not more than 30 mass parts.

5. The method for producing a calcium-containing composition with fixed CO₂ according to claim 1, wherein the temperature of the CO₂-containing gas is made not lower than 60 degree Celsius.

6. The method for producing a composition containing calcium with fixed CO₂ according to claim 5, wherein the temperature of the CO₂-containing gas is made not lower than 100 degree Celsius.

7. The method for producing a calcium-containing composition with fixed CO₂, according to claim 1, wherein the water content of the calcium-containing composition with fixed CO₂ is made not more than 1 mass %.

8. The method for producing a calcium-containing composition with fixed CO₂ according to claim 7, wherein the reactor is a fluidized bed reactor.

9. The method for producing a calcium-containing composition with fixed CO₂ according to claim 1, wherein the CO₂-containing gas is one extracted from a cement clinker production plant.

10. The method for producing a calcium-containing composition with fixed CO₂ according to claim 1, wherein the CO₂-containing gas is one extracted from a thermal power generation plant.

11. The method for producing a calcium-containing composition with fixed CO₂ according to claim 1, wherein said method further comprises a step of mixing the calcium-containing composition with fixed CO₂ into cement to a concentration not more than 5 mass %.

12. The method for producing a calcium-containing composition with fixed CO₂ according to claim 1, wherein said method further comprises a step of using the calcium-containing composition with fixed CO₂ as a concrete mixture material.

13. The method for producing a calcium-containing composition with fixed CO₂ according to claim 1, wherein the liquid water contains ammonia.

14. An apparatus for producing a calcium-containing composition with fixed CO₂, by making a mixture of a calcium-containing composition before fixing CO₂ and water in contact with a CO₂-containing gas, comprising:
a storage facility for storing the calcium-containing composition;
a fluidized bed reactor for carrying out carbonation of the calcium-containing composition;
a metered-volume feeder for supplying the calcium-containing composition to the fluidized bed reactor;
a water injection device for mixing water into the calcium-containing composition, before feeding to the fluidized bed reactor;
a blower for supplying the CO₂-containing gas to the fluidized bed reactor;
a dust collector for collecting dust contained in exhaust gas from the fluidized bed reactor; and
a blower for suctioning the exhaust gas from the dust collector.
